(19) United States
(12) Patent Application Publication
(10) Pub. No.: US 2008/0060333 A1
(43) Pub. Date: Mar. 13, 2008

(54) Apparatus and method for waste wood removal

(76) Inventor: Richard Frailey, Altus, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 11/511,990

(22) Filed: Aug. 29, 2006

(51) Int. Cl. A01D 45/02

(52) U.S. Cl. 56/82

(57) ABSTRACT

This invention is for an apparatus and method to remove wood debris after wood and shrubbery clearing has occurred. More specifically, this apparatus uses commercially available grinding rotors as a means to pick up and remove debris remaining after commercial tree and brush clearing efforts by using attachments such as flail hammers attached to a rotatable cylinder which are rotating in a direction opposite to the direction of travel. This action removes the debris and forces it into a basket. The basket may be dumped into a holding area or into a transport truck.

### BACKGROUND OF THE INVENTION

This invention removes brush and woody debris remaining after commercial tree and brush clearing efforts.

Debris commonly left in the wake of brush removal or wood cutting and grinding operations by machinery commonly used to clear forests, land, highway right-of-ways, power line right-of-ways or any other areas having brush and woody growth creates a hazard for mowing and field dressing equipment. Debris typically consists of wood, brush, limbs and leaves completely intact; partially shredded or broken; or completely shredded or broken into small pieces. Thus, it is desirable to remove this debris prior to continued operations in the cleared area. Traditional methods of woody debris removal require use of expensive, cumbersome earth moving equipment that damages the area which was just cleared. The earth moving equipment then dumps the combined dirt, rock and woody debris for subsequent processing by burial, sifting or hauled away to be disposed of elsewhere. There is very little recycling or reuse of the woody debris from such operations due to the expense to separate the materials. Additionally, it is often the case that the use of such heavy equipment requires the further expenditure of funds to rehabilitate the area just cleared.

In addition to clearing of land for commercial use, public use or safety, the growing interest in bio-fuels as well as a growing commercial market for mulch has led to the harvest of woody trees and shrubs for conversion to a mulch product. The current method of harvesting and mulching trees is a multi-step process requiring significant labor and equipment. Typically, the trees and shrubs are either cut down, cut up and hauled away to be mulched or they are cut down, mulched in place and the mulch collected by hand or heavy equipment. Both versions require numerous pieces of equipment and laborers.

Clearly, a need exists for an apparatus and method suitable for removing shrub and woody debris which alleviates the problems discussed above. This invention enables the elimination of several steps in the woody tree and shrub removal process and reduces the subsequent environmental impact. Further, the current invention lowers labor and fuel expenditures while reducing the number of pieces of equipment necessary for carrying out debris removal operations. Additionally, this invention increases the rate of return on the amount of bio-fuel manufactured over the amount of fuel used to harvest the key ingredients. Still further, this invention provides an environmentally friendly system for removing woody debris in a multitude of areas.

### SUMMARY OF THE INVENTION

In one embodiment, the present invention provides an apparatus designed to collect and remove brush and woody debris for disposal and recycling from previously cleared areas of land. The debris typically consists of previously processed natural material such as broken up tree trunks, tree limbs and shrubbery. The apparatus includes a vehicle on which is mounted a rotatable cylinder, a debris chute, a debris basket, a drive train providing power to the rotatable cylinder, a system suitable for dumping the debris basket and a conveyance suitable for traversing the ground. While traversing the ground, a protective enclosure surrounds the rotatable cylinder and skims the ground. The rotatable cylinder, a commercially available rotor, rotates counter to the motion of forward travel. On the rotor are devices employed as the principal means used to pick up the debris. In one embodiment the devices on the rotor are commercially available flail hammers which pick up and remove the debris from the ground. Another embodiment uses a fixed tooth device to pick up the debris. The rotor's rotation rate provides sufficient velocity to propel the debris up through the chute into the debris basket. The debris basket preferably includes a lid or an upper portion to the enclosure. Once full, the debris basket may be off-loaded through a dumping mechanism.

In another embodiment, the current invention provides an apparatus for removing brush and woody debris from the ground. The debris removal vehicle of the current invention comprises a vehicle adapted to receive a rotatable debris collection cylinder. The rotatable debris collection cylinder is associated with a drive mechanism suitable for spinning the cylinder at a high rate of speed in a direction counter-rotational to the forward direction of movement of the debris removal vehicle. Additionally, the vehicle includes a height adjusting system adapted to position and preferably maintains said rotatable cylinder a desired distance above the surface of the ground. As used in this disclosure, the phrase a “desired distance above the surface of the ground” means a distance sufficient to allow the rotatable cylinder with the attached devices to rotate without penetrating the ground in a manner causing the ground to be turned or tilled. Methods for setting this distance are well known to those skilled in the art. The debris removal vehicle further comprises a chute having a first end positioned adjacent to said rotatable cylinder and a second end positioned adjacent to a debris basket. The chute provides a path of travel for debris collected by the rotating cylinder to the debris basket. In the preferred embodiment, the debris basket is movable from a first position to a second position to facilitate dumping of collected debris.

In yet another embodiment, the current invention provides a method for removing brush and woody debris from the ground. The method of the current invention comprises removing a rotatable cutting or grinding cylinder from an existing piece of equipment such as a brush and wood cutting and grinding machine. The removed cylinder is subsequently installed in a debris removal vehicle which preferably has been constructed with a housing sized to receive the cylinder. Thus, the debris removal vehicle used in the method for removing brush and woody debris reduces manufacturing costs by using pre-existing hardware and by allowing the end item user to use their existing rotor in their new debris removal vehicle. Following positioning of the pre-existing cylinder in the vehicle adapted to receive said rotatable cylinder, the debris removal vehicle is moved across the ground while rotating the rotatable cylinder in a direction counter-rotational to the forward direction of travel. The rotation rate of the rotatable cylinder is a rate sufficient to remove debris from said ground and transport it through the chute to the debris basket. Once the debris basket is full, the vehicle is transported to a dump site where the basket is moved from the first position to the second position to dump the debris. Alternatively, a collection vehicle comes to debris removal vehicle and the basket is moved from the first position to the second position to dump the debris into the collection vehicle.

### BRIEF DESCRIPTION OF THE DRAWINGS

FIG. 1 shows a front-left view of the debris removal vehicle.

FIG. 2 shows a front-right view of the debris removal vehicle.

FIG. 3 shows a rear-left view of the debris removal vehicle.

FIG. 4 shows a rear-right view of the debris removal vehicle.

FIG. 5 shows a side view-right of the debris removal vehicle.

FIG. 6 shows a side view-left of the debris removal vehicle.

FIG. 7 shows a top view of the debris removal vehicle.

FIG. 8 shows a front view of the debris removal vehicle.

FIG. 9 shows a rear view of the debris removal vehicle.

FIG. 10 shows the belt and pulley assembly driving rotor.

FIG. 11 shows a front view of the rotatable cylinder with a representative flail hammer.

FIG. 12A shows a side view of a representative flail hammer.

FIG. 12B shows a front view of a representative flail hammer.

### DETAILED DESCRIPTION OF A PREFERRED EMBODIMENT

Debris removal vehicle 10 is powered by one of several means. Debris removal vehicle 10 of the current invention is adaptable to several configurations. For example, debris removal vehicle 10 may be towed by a tractor (not shown) or other similar heavy towing device. Preferably, the tow vehicle (not shown) also provides operational power to debris removal vehicle 10 through a power take off (PTO) source or a hydraulic system; however, in an alternative embodiment an independent power source on-board vehicle 10 will provide operational power. Both the PTO and hydraulic powered systems suitable for use with debris removal vehicle 10 are well known to those skilled in the art. Alternatively, debris removal vehicle 10 may be a self-propelled vehicle which includes a suitable engine to drive debris removal vehicle 10 and to provide power to other debris removal vehicle 10 operations. In another alternative embodiment, debris removal vehicle 10 and a debris cutting and grinding vehicle (not shown) are an integrated vehicle providing power to all components. The following provides a detailed description of the preferred embodiments of the current invention. However, various alternative embodiments will be apparent from the reading of this description.

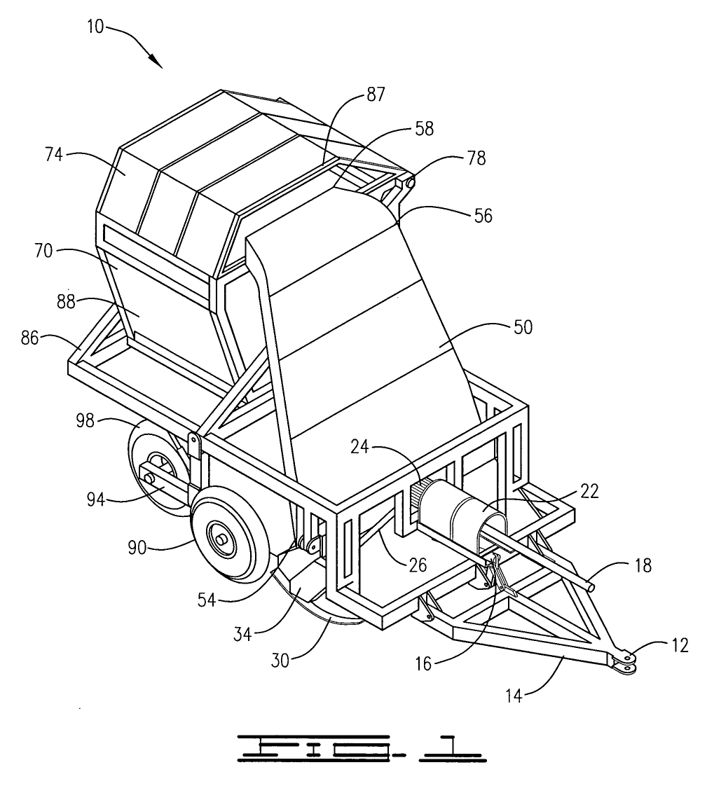

Referring now to the drawings, FIG. 1 depicts a front-left view of a preferred embodiment of a debris removal vehicle 10 configured for use with a towing vehicle (not shown) that provides power via a PTO system and supplies hydraulic power to vehicle 10. Vehicle 10 preferably includes a height control or leveling device 16 for positioning rotatable cylinder housing 30. In the preferred embodiment depicted in FIG. 1, leveling device 16 is a hydraulic cylinder 16 connected to a linkage attached to tongue 14. Tongue 14 is connected to the towing vehicle (now shown) by a towing connection 12 of the type know to those skilled in the art. Actuation of hydraulic cylinder 16 permits positioning and retention of tongue 14 at a desired height for rotatable cylinder housing 30 to skim the ground. Other height control or leveling mechanisms also suitable for use in the current invention include but are not limited to electrical motors or mechanical screw drives/gears.

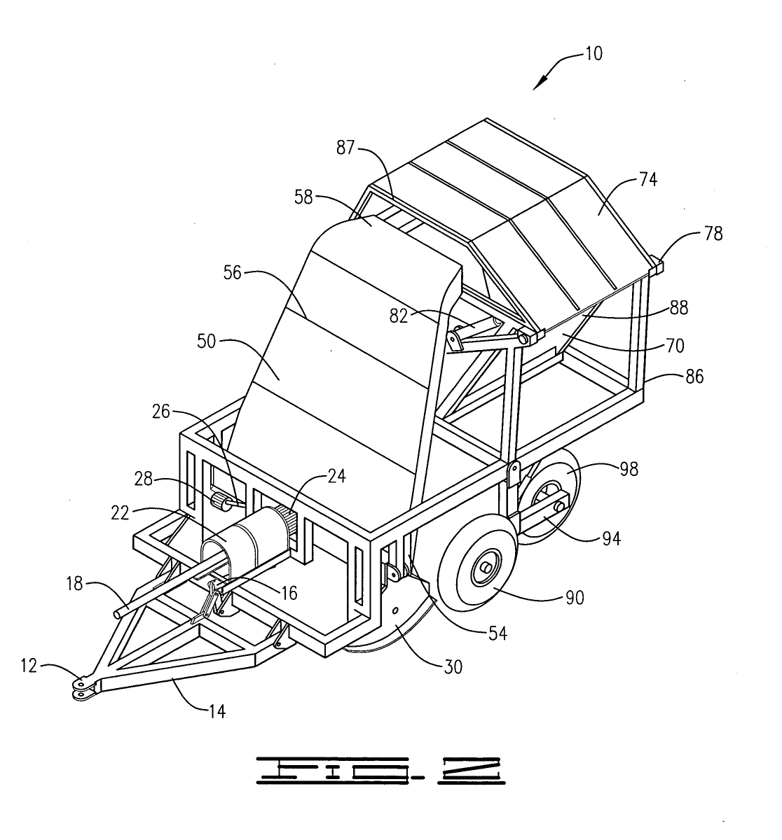

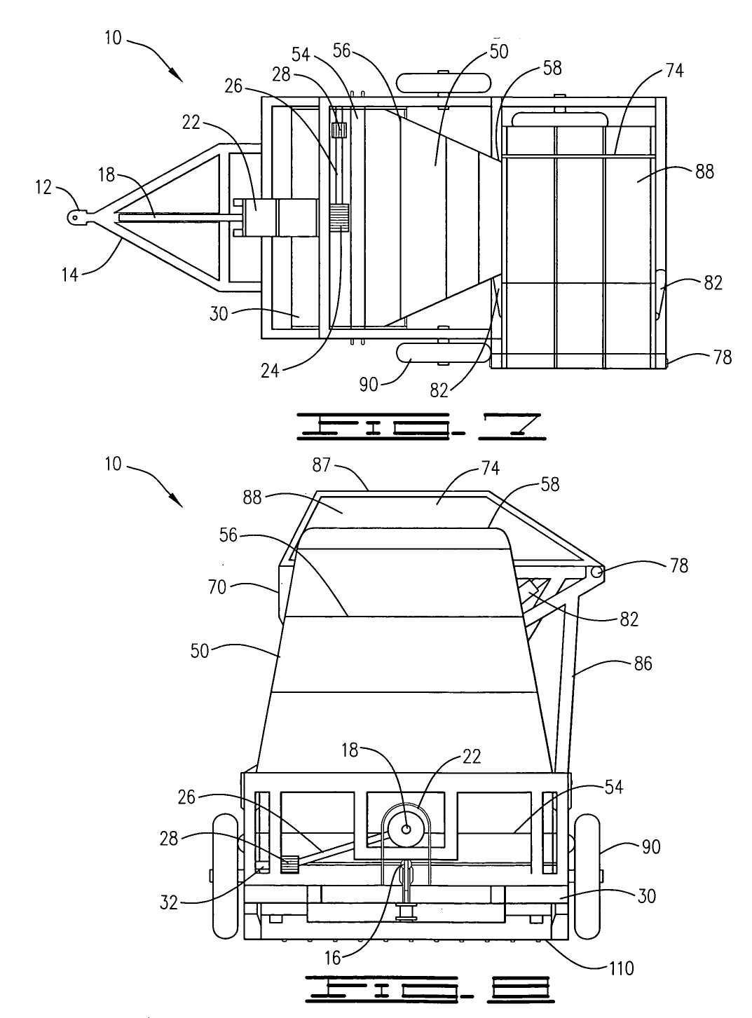

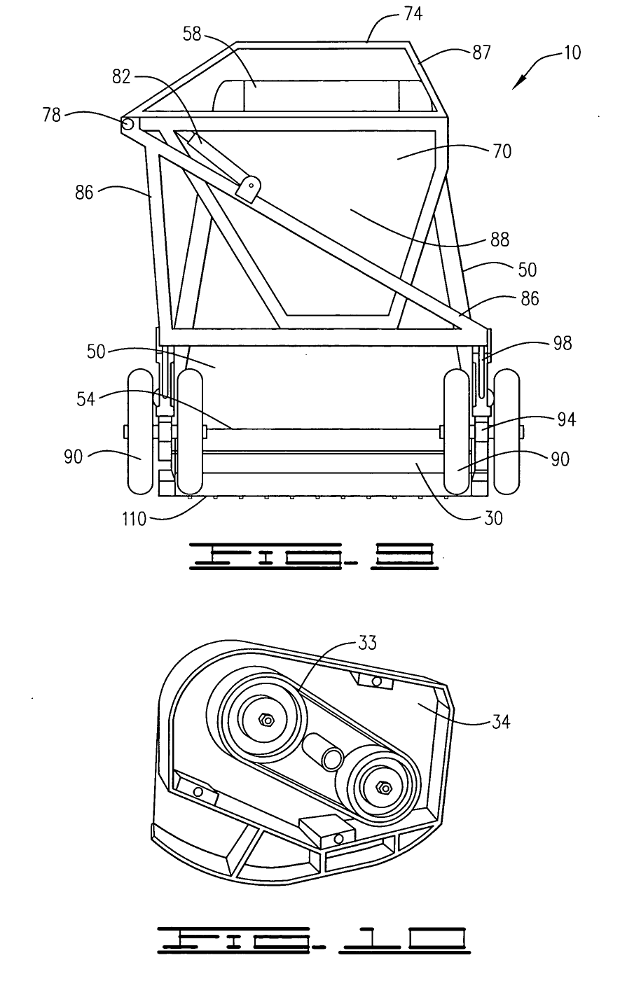

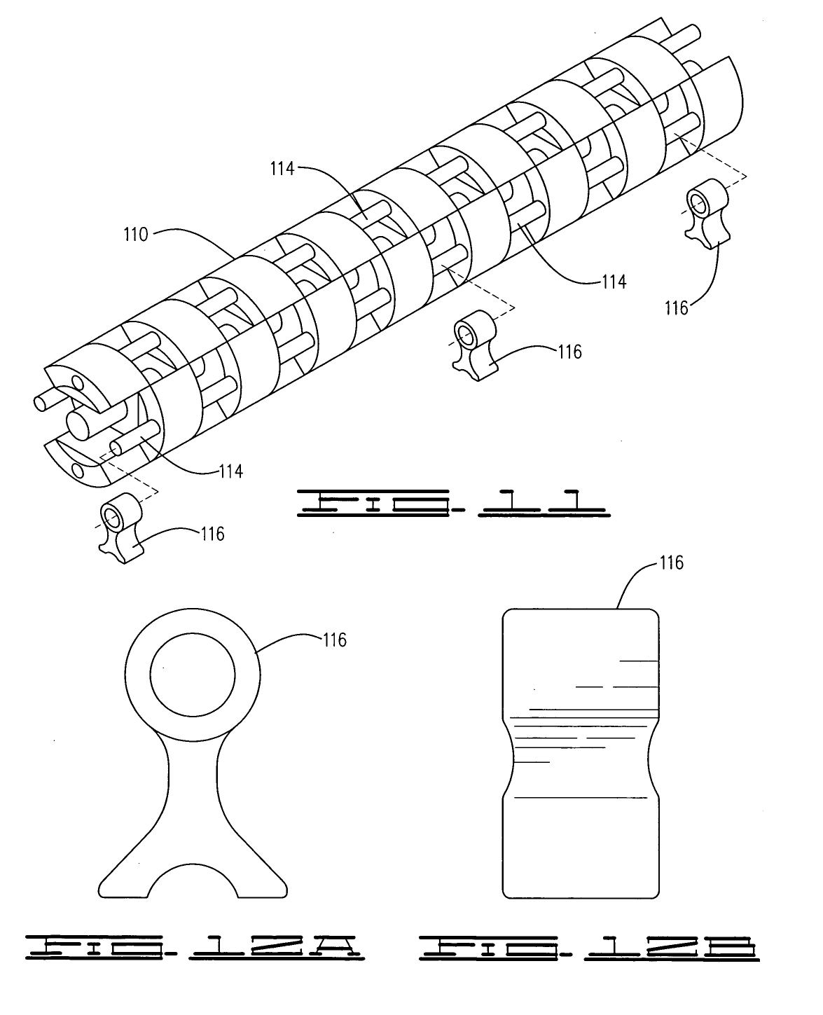

Referring to FIG. 2, drive shaft 18, including a power input coupling (not shown), is shown connected to the drive train gear box 24 carried by debris removal vehicle 10. Drive shaft 18 transfers power from the PTO of the towing vehicle (not shown) to debris removal vehicle 10 for operation of the rotatable cylinder 110, the hydraulic system and any other power driven device associated with debris removal vehicle 10. To ensure safety and longevity of drive shaft 18, a drive shaft cover 22 is provided to protect the coupling between drive shaft 18 and drive train gears 24. Drive train gears 24 are connected to the secondary drive shaft 26. Secondary drive shaft 26 is connected to the secondary gears 28 driving the pulley drive shaft 32, visible in FIG. 8, for the rotatable cylinder 110. As shown by FIG. 10, the pulley system 33 provides the input force to rotate rotatable cylinder 110 with sufficient speed to remove debris. Thus, power provided by the tow vehicle (not shown) or a motor associated with debris removal vehicle 10 is transferred via drive shaft 18 to drive train gear box 24, secondary drive shaft 26, secondary gears 28 and pulley system 33, which in turn is connected to the rotatable cylinder 110. FIG. 7 provides a top view of debris removal vehicle 10. FIG. 7 and FIG. 8 both clearly show the preferred arrangement of the drive train in elements 18, 22, 24, 26 and 28. Alternate power train configurations are anticipated such that proper power is supplied to rotate rotatable cylinder 110 and such alternate configurations are known by those skilled in the art.

In FIG. 3, rotatable cylinder housing 30 is shown with drive belt housing 34 which cooperates with pulley system 33, seen in FIG. 10, to provide power input to rotatable cylinder 110. As depicted in FIG. 5, positional control of rotatable cylinder housing 30 is provided by activation of hydraulic cylinder 16. In the preferred embodiment depicted in FIG. 11, rotatable cylinder 110 and debris pickup devices 116 attached at rotatable cylinder 110 device attachment points 114, are commercially available from Seppi m.® in Italy.

However, the current invention is not limited to the use of any particular manufacturer's rotatable cylinders 110 or debris pickup devices 116. Rather, each vehicle 10 is built to meet the existing or planned rotatable cylinder 110 operated by the end user. In the preferred embodiment devices 116 are flail hammers 116 as depicted in FIG. 11. Additionally, in the preferred embodiment rotatable cylinder 110 can be moved from a vehicle conducting grinding and cutting operations and installed within rotatable cylinder housing 30.

In another embodiment of the current invention, the grinding vehicle and the collecting vehicle 10 of the current invention are incorporated into a single vehicle (not shown) utilizing two rotatable cylinders 110. In this configuration one rotatable cylinder 110 is used to grind and the other is used to remove the resulting debris from the surface of the ground.

The preferred rotation of rotatable cylinder 110 is 2,100 revolutions per minute but it may be safely operated between 1,800 revolutions per minute and 2,400 revolutions per minute. The upper limit of the rotation speed being determined by the stability limits of the attachment of debris pickup devices 116 at maximum rotation. In view of the high rotational speed, rotatable cylinder housing 30 functions as a protective enclosure for safety purposes and, as recognized by one skilled in the art, should be sufficiently strong to withstand the unplanned departure of a flail hammer 116 or other devices from device attachment points 114.

As shown in FIG. 9, rotatable cylinder housing 30 is connected to the debris chute 50 at the debris chute inlet 54 that preferably extends across the entire area of rotatable cylinder housing 30. As shown in FIG. 3 and FIG. 9, rotatable cylinder 110 picks up and projects the debris into debris chute 50 at a high velocity. Debris in debris chute 50 exits at the debris chute outlet 58 into the debris basket 70. The basket part of debris basket 70 may be any vessel capable of collecting and retaining debris for later disposal. In the event of a jam in debris chute 50, the access panels 56 may be removed to clear debris jams within chute 50. In the preferred embodiment connectors (not shown) such as bolts with locking nuts and washers are used to secure access panels 56 to chute 50. However, those skilled in the art will recognize that any connectors may be used so long as they provide sufficient strength to withstand repeated impact from the debris. Brief examples of other connectors contemplated include screws, clamps and levered clamps. Clearing of jams in debris chute 50 is not considered to be a regular occurrence during the operation of the invention. Therefore, conventional connections which may be removed using tools typically available in a mechanics portable toolbox are preferred.

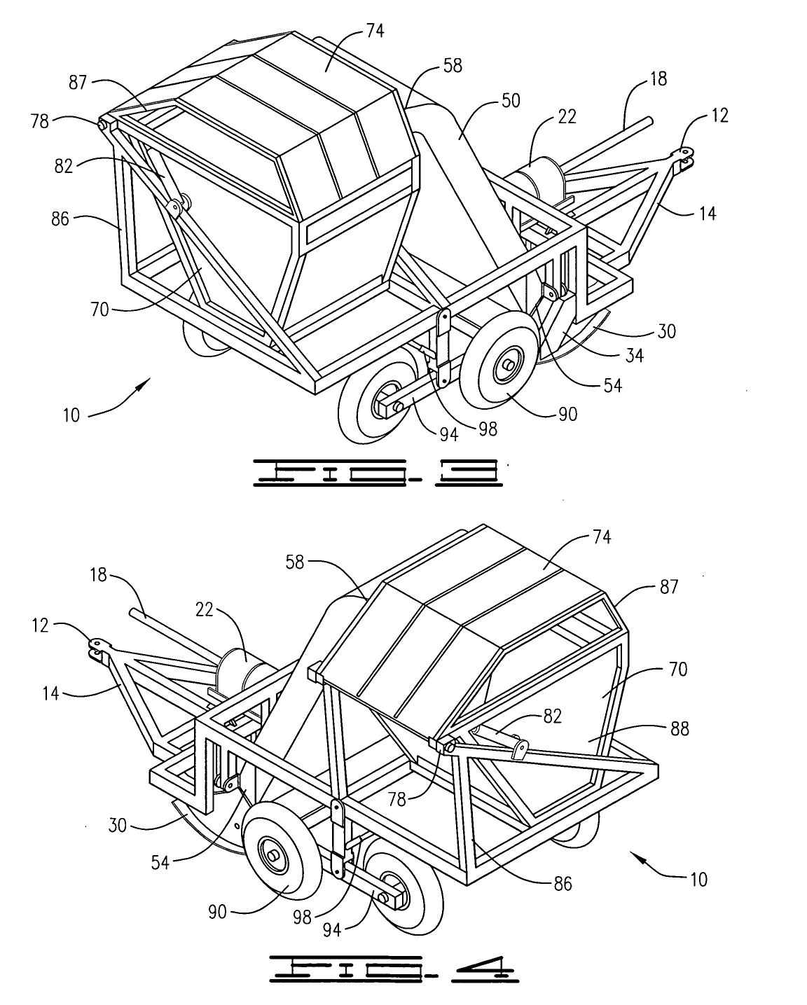

FIG. 4 shows debris basket 70 mounted within the debris basket structure 86. Access to debris basket 70 is through the debris basket lid 74 which opens by pivoting about the debris basket lid hinge 78. In order to withstand the high velocity impact of debris entering debris basket 70, the debris basket lid structure 87 is constructed from steel or other material having sufficient strength to absorb such impacts. FIG. 4 shows debris basket lid 74 with structural members running across it to provide form and strength to withstand debris projected into debris basket 70. In the current invention debris basket structure 86 and debris basket lid structure 87 are preferably hollow tubular steel to which the debris basket enclosure 88 is welded.

In the preferred embodiment and to provide consistency in construction of debris basket 70 and debris basket lid 74, debris basket enclosure 88 is constructed using the same material for both the debris basket 70 and the debris basket lid 74. Debris basket enclosures 88 may be made of any structurally sound material capable of being welded or affixed to debris basket structure 86 and debris basket lid structure 87. The welding or affixing is of the nature commonly used by those skilled in the art. Hollow steel tubing is the preferred embodiment of debris basket structure 88 and debris basket lid structure 87 in the current invention. The preferred embodiment for debris basket enclosure 88 is a heavy gauge steel mesh with sufficient strength to withstand the impact of logs left behind by field clearing operations hitting the center of an exposed panel of debris basket structure 88. The preferred heavy gauge steel mesh of debris basket enclosure 88 is preferably welded at structurally sound intervals to the debris basket structure 86. Similarly, sections of debris basket enclosure 88 are also preferably welded at structurally sound intervals on the debris basket lid structure 87. It will be obvious to those skilled in the art that the connection of debris basket structure 86, debris basket lid structure 87 and debris basket enclosure 88 may also be accomplished by using appropriately sized bolts, screws or other connectors.

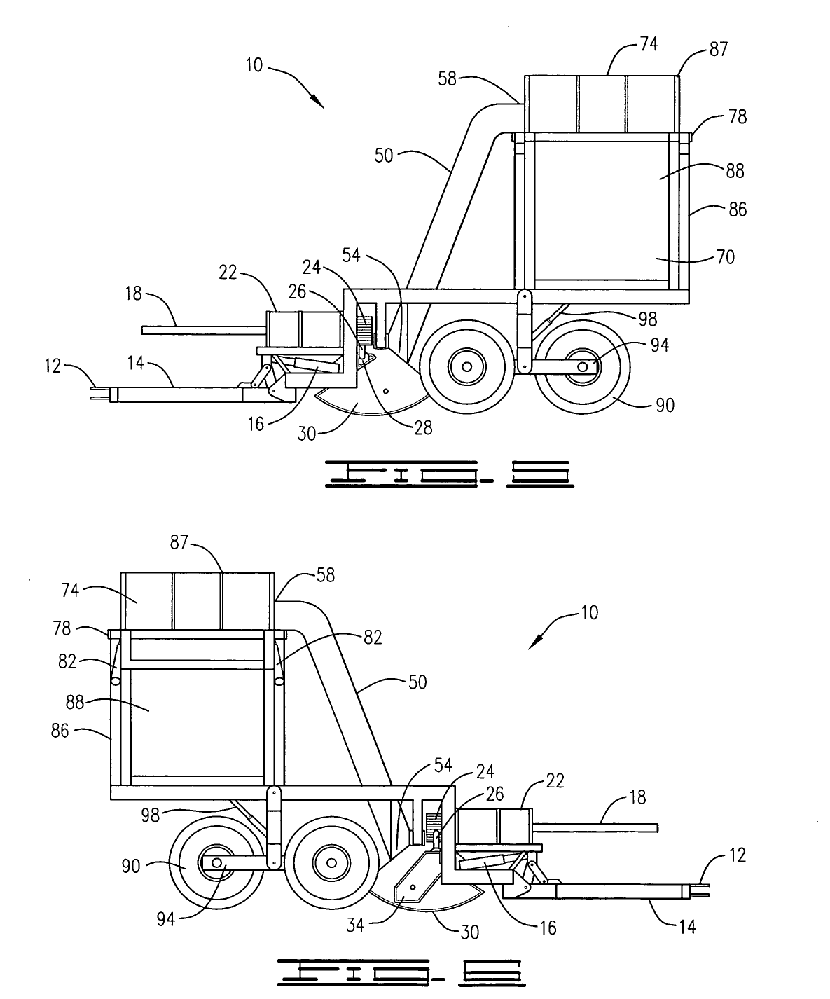

When the debris basket 70 reaches capacity it is necessary to off load or dump the collected debris. The debris is removed by dumping it at a single collection point or in another vehicle that will haul it away for processing elsewhere. In FIG. 4 and FIG. 9 only one of the two basket position control hydraulic cylinders 82 is shown. FIG. 6 shows both of basket position control hydraulic cylinders 82. Both basket position control hydraulic cylinders 82 are simultaneously activated to force debris basket 70 to move from position one to position two. Position one is the normal operating position of debris basket 70. In the preferred embodiment, position two of debris basket 70 is such that basket 70 elevates and dumps over the left side of debris vehicle 10. This dumping action is depicted by FIG. 9. However, in an alternate embodiment, switching the position of debris basket lid hinge 78 and/or installing a second, lower dumping hinge (not shown) for position two of debris basket 70 provides for dumping in a forward manner on the right side of vehicle 10. In either case, position two of debris basket 70 is a position which allows gravity to force open debris basket lid 74 as it rotates around debris basket lid hinge 78.

In addition to providing a configuration suitable for gravity operation of debris basket lid 74, the current invention also contemplates hydraulic or mechanical operation of debris basket lid 74 to control opening and closing of debris basket lid 74. Another embodiment includes a locking mechanism (not shown) to keep the debris basket lid 74 from opening unexpectedly. Further considered as an embodiment of the invention is a door or a dump catch instead of the debris basket lid 74.

Further shown in FIG. 4 is the tire/wheel assembly 90 of vehicle 10. In FIG. 4, tire/wheel assembly 90 is shown mounted in an outer forward and an inner rearward position along the wheel support structure walking beam 94. This embodiment keeps the tire/wheel assembly from following within the same tracks. Another embodiment (not shown) places tire/wheel assembly 90 in the same line of track external or internal to wheel support structure walking beam 94 or provides for dual front and rear tire/wheel assembly for a total of four tires on each side of the vehicle. Wheel support structure walking beam 94 is controlled by hydraulic cylinder 98.

FIG. 8 shows rotatable cylinder 110 with devices attached to it touching the ground when debris vehicle 10 is employed for debris removal. Referring now to FIG. 11, rotatable cylinder 110 is shown with device attachment points 114. Rotatable cylinder 110 is comprised of a commercially available rotor equipped with typical flail hammers 116 or fixed tooth devices (not shown). Though flail hammers 116 and the fixed tooth devices (not shown) are identified as the preferred embodiment, any similar devices known to be affixed on similar rotatable devices which can be employed to pick up or break up wood and shrubbery should function satisfactorily in the current invention. As previously disclosed the preferred rotatable cylinder 110 and the preferred flail hammers 116 affixed at device attachment points 114 are from Seppi m.® of Italy.

Highlighting the disclosed preferred embodiment as shown in FIG. 1 through FIG. 9, the following focuses on the methods of using the invention. In a preferred embodiment, debris removal vehicle 10 traverses the ground in a forward motion by being towed. Rotatable cylinder housing 30 is raised or lowered to contact the ground by controlling hydraulic cylinder 16 connected to hydraulically operated trailer tongue 14. In the preferred operational position, rotatable cylinder housing 30 skims the surface of the ground and is designed to maintain contact with the ground as vehicle 10 moves forward. The variations in terrain are handled between debris removal vehicle 10 and the towing vehicle. While traversing the ground in a forward motion, rotatable cylinder's 110 rotation is driven in a direction that is opposite to the forward motion of the towing vehicle (not shown) by the drive train comprised of elements 18, 22, 24, 26, 28 and 32. The preferred rotation of the rotatable cylinder is 2,100 revolutions per minute, but may operate between 1,800 revolutions per minute and 2,400 revolutions per minute with the limit of the rotation speed being determined by the type of flail hammers 116 or other devices attached to rotatable cylinder 110. Rotatable cylinder housing 30 functions as both a guide and as a protective enclosure for safety purposes and should be sufficiently strong to withstand the unplanned departure of a flail hammer 116 or other attached device 116 from rotatable cylinder device attachment points 114.

During operations rotatable cylinder 110 skims the ground with flail hammers 116 or the fixed tooth devices picking up the debris. As depicted in FIG. 5, actuation of hydraulic cylinder 16 raises or lowers vehicle 10 to position rotatable cylinder housing 30 and rotatable cylinder 110 in contact with the ground. Preferably hydraulic cylinder 16 maintains contact between rotatable cylinder housing 30 and rotatable cylinder 110 with the ground. Alternatively, mechanical height adjusting elements known to those skilled in the art may replace hydraulic cylinder 16 to effectuate the same action. The wood and shrub debris is removed from the ground by rotatable cylinder 110 rotating quickly with devices 116 making physical contact with the wood and shrub debris such that the debris is picked up by devices 116 and thrown up into debris chute 50 at a high velocity. Preferably the debris is thrown into debris chute 50 with sufficient force such that its momentum carries the debris to the upper portion of debris basket 70. It is contemplated that an alternate embodiment of debris chute 50 might include a conveyor belt type device (not shown) or other similar arrangement that assists movement of debris from debris chute inlet 54 to debris chute outlet 58.

Once debris basket 70 is full or the job is done, debris removal vehicle 10 is either taken to a central dumping point or some form of collection vehicle comes to debris removal vehicle 10. Dumping of debris from basket 70 is achieved by moving debris basket 70 from position one to position two. In the preferred embodiment, debris basket 70 position control hydraulic cylinders 82 extend until debris basket 70 tips a distance sufficient to open debris basket lid 74 and empty the contents of debris basket 70. Debris basket lid 74 pivots around debris basket lid hinge 78 to facilitate dumping. Though not shown, debris basket lid 74 optionally includes a latching mechanism to precluding opening thereof during debris collection.

Typically each vehicle 10 is custom designed to a specification for a specific use. Specific use is meant to be the specific location of use of the vehicle such as forestry or urban use. Further, specific use encompasses the type of woody trees or shrubs to be removed. Still further, each vehicle 10 will preferably accommodate one of several commercially available rotors 110 which are available in differing widths and diameters. Typically, vehicle 10 is sized to receive the particular size rotor 110 currently in the possession of the purchaser or fabricator or the size that purchaser or fabricator plans on purchasing. It is also considered to be an embodiment of this invention to be able to remove an existing rotor 110 being used for grinding/mulching purposes on a separate vehicle or same vehicle 10 and quickly install it into rotor housing 30 of vehicle 10.

With regard to debris basket 70, the current invention also contemplates a dumping action wherein debris basket 70 carries a door (not shown) on the side of debris basket 70 instead of a lid 74. When basket 70 is moved from position one to position two the door will open allowing the collected debris to be dumped into a single collection point. The opening action may occur via hydraulics, gravity, motors, gears or any known method to open and close doors. As discussed above a variety of mechanical, electrical or hydraulic actions is contemplated for controlling other types of lids. Another embodiment is where the dumping action is a gravity dump (not shown) provided on the bottom of the vehicle. The gravity dump will be actuated by any means known in the industry. It is contemplated that the basket 70 may ride either high on the back of the vehicle or be attached anywhere physically configurable behind the rotatable cylinder. Optionally, a debris settling mechanism is provided on debris basket 70 through use of hydraulic or electric shakers.

It is contemplated that the hydraulics for leveling and dumping may be replaced by electric motors and/or screw gears. Further, debris removal vehicle 10 of the current invention may be powered by one of several arrangements. For example, in the preferred embodiment of FIGS. 1-11, debris removal vehicle 10 is towed by a tractor (not shown) or other conventional farm or construction implement (not shown). Preferably, the towing vehicle includes a PTO source suitable for providing rotational power to a drive shaft 18 carried on debris removal vehicle 10. Alternatively, debris removal vehicle 10 may be equipped with a hydraulic system suitable for actuating all moving elements associated with debris removal vehicle 14. In this embodiment, the towing vehicle provides hydraulic power to debris removal vehicle 10. Still further, the current invention contemplates an embodiment wherein debris removal vehicle 10 is a self-propelled vehicle powered by a suitable motor. Additionally, the current invention contemplates an integrated self-propelled or towed vehicle incorporating a cutting and grinding assembly and a debris removal assembly of the type described above. Further, the drive train of the preferred embodiment is only one of many possible combinations known to those skilled in the art. Other combinations including but not limited to drive linkages having a single drive shaft or multiple drive shafts are also contemplated by the present invention. Thus, as one skilled in the art will recognize from the preceding detailed disclosure, the debris removal vehicle of the current invention is readily adaptable to various configurations.

Thus, the present invention is well adapted to carry out the objects and attain the ends and advantages mentioned as well as those inherent therein. While preferred embodiments of the present invention have been illustrated for the purpose of the present disclosure, changes in the arrangement and construction of parts and the performance of steps can be made by those skilled in the art, which changes are encompassed within the scope and spirit of the present invention as defined by the appended claims.

I claim:

1. An apparatus for removing brush and woody debris from the ground comprising:
a rotatable cylinder adapted to pick up said debris, wherein said rotatable cylinder is driven by a power source associated with said apparatus;
a basket carried by said apparatus for receiving said debris;
a chute positioned adjacent to said rotatable cylinder to receive said debris, said chute directing said debris to said basket.

2. The apparatus of claim 1, wherein said rotatable cylinder is mounted within a rotatable cylinder housing.

3. The apparatus of claim 2, further comprising a height adjusting system adapted to position said rotatable cylinder a desired distance above the surface of the ground.

4. The apparatus of claim 3, wherein said height adjusting system is a hydraulic system.

5. The apparatus of claim 4, further comprising a tongue suitable for towing said vehicle and said height adjusting system adjusts vehicle height by controlling the height of said tongue.

6. The apparatus of claim 4, wherein said hydraulic system is also associated with said basket and provides the means to move said basket from the first to second position.

7. The apparatus of claim 1, wherein devices mounted on said rotatable cylinder are flail devices or fixed tooth devices.

8. The apparatus of claim 1, wherein said rotatable cylinder is driven by a drive mechanism wherein said rotatable cylinder rotates counter-rotationally to a forward direction of travel.

9. An apparatus for removing brush and woody debris from the ground comprising:
a vehicle adapted to receive a rotatable cylinder;
a drive mechanism suitable for driving said rotatable cylinder carried by said vehicle;
a height adjusting system carried by said vehicle, said height adjusting system adapted to position said rotatable cylinder a desired distance above the surface of the ground; and,
a basket for receiving debris from said rotatable cylinder, said basket being movable from a first position to a second position;

10. The apparatus of claim 9, further comprising a rotatable cylinder housing and a chute having a first end position adjacent to said rotatable cylinder housing and a second end positioned adjacent to said basket.

11. The apparatus of claim 10, wherein said a rotatable cylinder is adapted to pick up said brush and woody debris and is installed within said rotatable cylinder housing.

12. The apparatus of claim 11, wherein said drive mechanism rotates said rotatable cylinder counter-rotationally to a forward direction of travel.

13. The apparatus of claim 9, wherein devices mounted on said rotatable cylinder are flail devices or fixed tooth devices.

14. The apparatus of claim 9, wherein said height adjusting system is a hydraulic system.

15. The apparatus of claim 14, further comprising a tongue suitable for towing said vehicle and said height adjusting system adjusts vehicle height by controlling the height of said tongue.

16. The apparatus of claim 14, wherein said hydraulic system is also associated with said basket and provides the means to move said basket from the first to second position.

17. An apparatus for removing brush and woody debris from the ground comprising:
a vehicle adapted to receive a rotatable cylinder;
a drive mechanism carried by said vehicle suitable for driving said rotatable cylinder;
a hydraulic height adjusting system adapted to position said rotatable cylinder a desired distance above the surface of the ground;
a basket for receiving debris carried by said vehicle, said basket being movable from a first position to a second position;
a chute having a first end position adjacent to said rotatable cylinder and a second end positioned adjacent to said basket.

18. The apparatus of claim 17, further comprising a rotatable cylinder housing and a chute having a first end position adjacent to said rotatable cylinder housing and a second end positioned adjacent to said basket.

19. The apparatus of claim 18, wherein said a rotatable cylinder is adapted to pick up said brush and woody debris and is installed in said rotatable cylinder housing.

20. The apparatus of claim 17, wherein devices mounted said rotatable cylinder are a flail style device or a fixed tooth device.

21. The apparatus of claim 17, further comprising a tongue suitable for towing said vehicle and said height adjusting system adjusts vehicle height by controlling the height of said tongue.

22. The apparatus of claim 17, wherein said hydraulic system is also associated with said basket and provides the means to move said basket from the first to second position.

23. A method for removing brush and woody debris from the ground comprising the steps of:
removing a rotatable cylinder from a brush and wood cutting and grinding machine;
providing a vehicle adapted to receive said rotatable cylinder wherein said vehicle comprises:
a drive mechanism associated with said rotatable cylinder;
a height adjusting system associated with said vehicle, said height adjusting system adapted to position said rotatable cylinder a desired distance above the surface of the ground;
a basket for receiving debris, said basket being movable from a first position to a second position;
positioning said rotatable cylinder removed from said brush and wood cutting and grinding machine in said vehicle adapted to receive said rotatable cylinder; and
moving said vehicle across the ground while rotating said rotatable cylinder in a direction counter-rotationally to the forward direction of travel, said rotatable cylinder rotating at a rate sufficient remove debris from said ground.

24. The method of claim 23, further comprising the step of transporting said debris from said rotatable cylinder to said basket.

25. The method of claim 23, wherein said vehicle further comprises a housing positioned around said rotatable cylinder and a chute having a first end positioned adjacent to said housing and a second end adjacent to said basket and wherein said rotatable cylinder rotates at a speed sufficient to propel debris through said chute to said basket.

26. The method of claim 23, further comprising the step of adjusting said height adjusting mechanism such that said rotatable cylinder is positioned a desired distance above the surface of the ground during movement of said vehicle across the ground.

27. A method for removing brush and woody debris from the ground comprising the steps of:
providing a rotatable cylinder carrying debris removal devices;
providing a vehicle adapted to receive said rotatable cylinder wherein said vehicle comprises:
a drive mechanism associated with said rotatable cylinder;
a height adjusting system associated with said vehicle, said height adjusting system adapted to position said rotatable cylinder a desired distance above the surface of the ground;
a basket for receiving debris, said basket being movable from a first position to a second position;
positioning said rotatable cylinder in said vehicle adapted to receive said rotatable cylinder;
moving said vehicle across the ground while rotating said rotatable cylinder in a direction counter-rotationally to the forward direction of travel, said rotatable cylinder rotating at a rate sufficient remove debris from said ground.

28. The method of claim 27, further comprising the step of transporting said debris from said rotatable cylinder to said basket.

29. The method of claim 27, wherein said vehicle further comprises a housing positioned around said rotatable cylinder and a chute having a first end positioned adjacent to said housing and a second end adjacent to said basket and wherein said rotatable cylinder rotates at a speed sufficient to propel debris through said chute to said basket.

30. The method of claim 27, further comprising the step of adjusting said height adjusting mechanism such that said rotatable cylinder is positioned a desired distance above the surface of the ground during movement of said vehicle across the ground.
